(19) United States
(12) Patent Application Publication
(10) Pub. No.: US 2013/0268126 A1
(43) Pub. Date: Oct. 10, 2013

(54) AIR CONDITIONING INFORMATION ESTIMATION DEVICE, CONTROL METHOD OF AIR CONDITIONING INFORMATION ESTIMATION DEVICE, AND CONTROL PROGRAM

(71) Applicants: Taro Iwami, Kyoto-shi (JP); Kosuke Tsuruta, Kyoto-shi (JP); Maki Endo, Kyoto-shi (JP); Yumi Tsutsumi, Kyoto-shi (JP)

(72) Inventors: Taro Iwami, Kyoto-shi (JP); Kosuke Tsuruta, Kyoto-shi (JP); Maki Endo, Kyoto-shi (JP); Yumi Tsutsumi, Kyoto-shi (JP)

(73) Assignee: OMRON Corporation, Kyoto (JP)

(21) Appl. No.: 13/884,792

(22) PCT Filed: Mar. 23, 2011
(86) PCT No.: PCT/JP2011/056953

§ 371 Date: Jun. 6, 2013

(30) Foreign Application Priority Data
Dec. 28, 2010 (JP) 2010-293923

(51) Int. Cl. G05D 23/19

(52) U.S. Cl. CPC G05D 23/1919
USPC 700/276

(57) ABSTRACT

The air conditioning information estimation device estimates the amount of power consumed by an air conditioner which adjusts the temperature in a room based on a temperature set-point. The air conditioning information estimation device has a storage unit configured to store a temperature set-point, and a power consumption amount specification unit configured to specify the energy consumption amount of the air conditioner during a prescribed period during which the air conditioner performs air conditioning.

### CROSS-REFERENCE TO RELATED APPLICATION(S)

This application claims the benefit of priority from Japanese Patent Application No. 2010-293923, filed 28 Dec. 2010, and International Application No. PCT/JP2011/056953, filed 23 Mar. 2011 and designating the United States, the entire contents of which is incorporated herein by reference for all purposes.

### BACKGROUND

The present invention relates to an air conditioning information estimation device that estimates an energy consumption amount of an air conditioner.

Nowadays, there is increasing attention directed to reduction of an amount of carbon dioxide emission and reduction of the energy consumption amount. In order to reduce the energy consumption amount, it is necessary to estimate the energy consumption amount of the air conditioner.

For example, Japanese Unexamined Patent Publication No. 2010-112697 (published on May 20, 2010) (Patent Document 1) discloses an energy saving support device presenting energy saving margin information for deciding from which air conditioner the air conditioning efficiency should be improved in the case that plural air conditioners are placed in a building. The energy saving support device estimates a consumed power amount of the air conditioner having a low COP (Coefficient Of Performance) from running data of the air conditioner in the case of use of the air conditioner in which the COP is improved. In the COP, cooling (heating) capacity [kW] is divided by a consumed power [kW]. The running data includes a running state of the air conditioner, specifically includes power-on and -off, turn-on and-off of a thermostat, a running mode (a cooling mode, a heating mode, or a fan mode), and a temperature set-point. Based on the energy saving margin information, a manager of the air conditioner (a manager of the building) can understand the priority for improving (exchanging) the air conditioner.

According to the configuration of Patent Document 1, the consumed power amount can be understood when the COP of the air conditioner is improved. However, in order to improve the COP, it is necessary to improve the air conditioner itself, or it is necessary to replace the air conditioner with an air conditioner having good efficiency. Therefore, a large cost is required to reduce the energy consumption amount.

In order to reduce the energy consumption amount without increasing the cost, it is useful to estimate the energy consumption amount in changing a temperature set-point which is an adjustable parameter of the air conditioner. When the energy consumption amount can be understood in changing the temperature set-point, the temperature set-point can be adjusted in consideration of comfort and energy saving.

However, in the conventional technology, many pieces of information (such as the power-on and -off, the temperature set-point, and an air volume, a ventilation temperature, and a ventilation volume) on the air conditioner and environment are required to estimate the consumed power amount. In the conventional technology, for example, because an influence of heat accumulation of a floor and a wall of a room is not considered, the energy consumption amount cannot suitably be estimated when the temperature set-point is changed. Therefore, the temperature set-point suitable to reduce the energy consumption amount cannot be estimated.

An object thereof is to construct an air conditioning information estimation device that can estimate the energy consumption amount of the air conditioner with the temperature set-point as the parameter.

### SUMMARY

Disclosed is an air conditioning information estimation device for estimating an energy consumption amount of an air conditioner, the air conditioner adjusting an atmospheric temperature in a prescribed area based on a temperature set-point. The air conditioning information estimation device includes a storage unit configured to store a temperature set-point, a consumption amount specification unit configured to specify the energy consumption amount of the air conditioner in a prescribed period in which the air conditioner is configured to perform air conditioning as a value y of a function, the function being expressed by

y=f(a)+g(b)+y

using a function f (a) in which a first feature quantity a wherein a=x−xs is used as a variable, a function g (b) in which a second feature quantity b wherein b=xc−xs is used as a variable, and a constant y, where x is the atmospheric temperature in the prescribed area in the prescribed period, xs is the temperature set-point in the prescribed period, and xc is the initial atmospheric temperature in the prescribed area when the air conditioner starts the air conditioning before the prescribed period.

Disclosed is a method of controlling an air conditioning information estimation device that estimates an energy consumption amount of an air conditioner, the air conditioner adjusting an atmospheric temperature in a prescribed area based on a temperature set-point, the method of controlling air conditioning information estimation device includes a consumption amount specification step of specifying the energy consumption amount of the air conditioner in a prescribed period in which the air conditioner performs air conditioning as a value y of a function, the function being expressed by

y=f(a)+g(b)+y

using a function f (a) in which a first feature quantity a wherein a=x−xs is used as a variable, a function g (b) in which a second feature quantity b wherein b=xc−xs is used as a variable, and a constant γ, where x is the atmospheric temperature in the prescribed area in the prescribed period, xs is the temperature set-point in the prescribed period, and xc is the initial atmospheric temperature in the prescribed area when the air conditioner starts the air conditioning before the prescribed period.

According to the above configuration, the energy consumption amount can be estimated using the first feature quantity a and the second feature quantity b. The second feature quantity b is a value reflecting an initial temperature at the beginning of the air conditioning, and the second feature quantity b becomes a parameter that indicates the influence of the heat accumulation of a structure (such as the wall and the floor) around the prescribed area. Therefore, the energy consumption amount of the air conditioner can be estimated in consideration of the influence of the heat accumulation.

According to the above configuration, the energy consumption amount can be estimated from the atmospheric temperature, the initial temperature, and the temperature set-point in the area. Therefore, because the parameter to estimate the energy consumption amount can be acquired, it is not necessary to install a temperature sensor and the like in order to acquire ambient temperature outside the area. Therefore, the air conditioning information estimation device can be introduced at low cost.

As described above, the energy consumption amount of the air conditioner can be estimated in consideration of the influence of the heat accumulation.

In the conventional technology, because the many pieces of information on the air conditioner and environment are required to estimate the energy consumption amount, the configuration becomes complicated or a lot of labor is spent to input the many pieces of information.

In at least an embodiment of the present invention, the parameter to estimate the energy consumption amount can be acquired. Therefore, the configuration of the air conditioning information estimation device can be simplified, and the air conditioning information estimation device can be introduced at low cost.

### BRIEF DESCRIPTION OF THE DRAWINGS

FIG. 1 is a schematic diagram illustrating a system to which an air conditioning information estimation device according to an embodiment of the present invention is applied.

FIG. 2 is a graph illustrating examples of a power consumption amount per hour of an air conditioner and a corresponding room temperature for one week.

FIG. 3 is a block diagram illustrating a functional configuration of the air conditioning information estimation device according to an embodiment.

FIG. 4 is a view illustrating an example of measurement data read in the air conditioning information estimation device.

FIG. 5 is a view illustrating a potential for improvement amount and a target temperature set-point, which are displayed or output.

FIG. 6 is a view illustrating display examples of the a potential for improvement amount and target temperature set-point.

FIG. 7 is a view illustrating a processing flow in which the air conditioning information estimation device specifies a power consumption amount estimation function.

FIG. 8 is a view illustrating a processing flow in which the air conditioning information estimation device estimates the power consumption amount to specify the target temperature set-point and the a potential for improvement amount.

FIG. 9 is a view illustrating a graph of a temperature x and Δxm.

### DETAILED DESCRIPTION

An embodiment will be described below with reference to the drawings. Hereinafter, air conditioning (cooling) in summertime in which ambient temperature is higher than an area of an air conditioning subject is mainly described by way of example, but the case of air conditioning (heating) is also applicable.

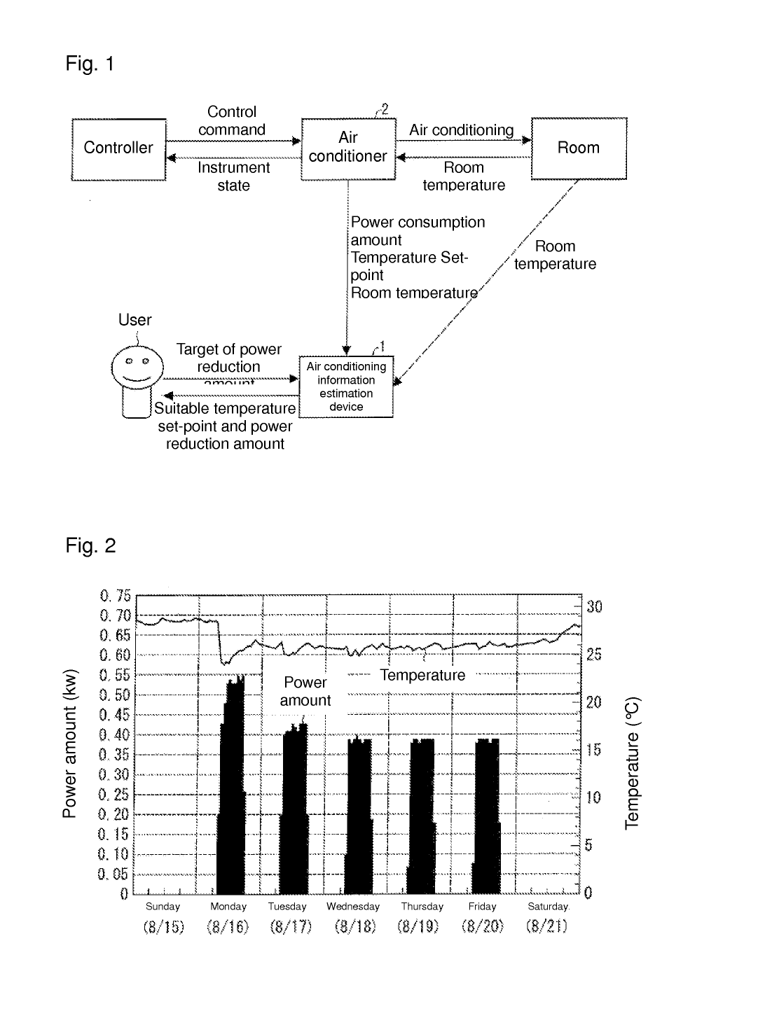

FIG. 1 is a schematic diagram illustrating a system to which an air conditioning information estimation device 1 according to an embodiment is applied. An air conditioner 2 receives a control command (such as power-on and -off and designation of a temperature set-point) from a controller, and returns a running state of the air conditioner 2 to the controller. The air conditioner 2 performs the air conditioning (temperature control) in a prescribed area, such as a building based on the temperature set-point. The air conditioner 2 measures a room temperature and a power consumption amount, and transmits pieces of information on the room temperature, temperature set-point, and power consumption amount to the air conditioning information estimation device 1. The information on the room temperature may directly be transmitted to the air conditioning information estimation device 1 from a temperature sensor installed in a room. A user inputs a reduction target (such as a target reduction rate) of the power consumption amount to the air conditioning information estimation device 1. The air conditioning information estimation device 1 estimates the power consumption amount (the energy consumption amount) with respect to the air conditioner 2 when the temperature set-point is changed, and the air conditioning information estimation device 1 specifies a suitable target temperature set-point in order to reduce the power consumption amount, and presents the target temperature set-point and the power reduction amount at that time to the user.

### Power Consumption Amount Estimation Model

A method of estimating the power consumption amount according to an embodiment will be described below.

FIG. 2 is a graph illustrating examples of the power consumption amount per hour of the air conditioner and the corresponding room temperature for one week. A horizontal axis expresses time, a left vertical axis expresses the power consumption amount per hour, and a right vertical axis expresses the temperature. FIG. 2 illustrates the power consumption amounts and room temperatures (atmospheric temperatures in the room) for one week from Sunday (August 15th) to Saturday (August 21st). The room is one of an office building, and the air conditioner performs the air conditioning of the room in daytime (9:00 to 18:00) from Monday (August 16th) to Friday (August 20th). The room temperature is maintained at a low temperature close to the temperature set-point (26° C.) because the air conditioner operates from Monday to Friday. The room temperature rises because the air conditioner does not operate on Saturday and Sunday. Referring to FIG. 2, while the temperature set-point is always kept constant, the room temperature changes due to various factors such as a temperature change around the room. The ambient temperature indicated the similar temperature change on any day of the week.

As can be seen from FIG. 2, the power consumption amount becomes the largest on Monday (August 16th), the power consumption amount is the second largest on Tuesday (August 17th), and the power consumption amount is small from Wednesday (August 18th) to Friday (August 20th). Because the room temperature rises on Saturday and Sunday, the temperature is higher than that of other days (Tuesday to Friday) immediately before the air conditioner operates on Monday. Therefore, an increase in start-up (initial) consumed power amount on Monday can easily be presumed. However, even after the room temperature becomes the temperature set-point or less, the power consumption amount per hour on Monday is larger than that of other days (Tuesday to Friday). This tendency is observed in piece of data of any week irrespective of the ambient temperature.

The reason the power consumption amount per hour on Monday increases as a whole is that heat capacities of structures, such as a wall and a floor around the room, and air of gaps in the wall and floor exist. During Saturday and Sunday on which the air conditioner does not operate, the room temperature rises and the heat is accumulated in the wall and floor and the air of the gaps in the wall and floor. When the air conditioner operates on Monday, although the room temperature decreases rapidly, the wall and floor that are insulated to a certain degree provide the accumulated heat to the air in the room bit by bit. Therefore, even after the room temperature becomes the temperature set-point or less, the power consumption amount per hour on Monday is larger than that of other days (Tuesday to Friday).

An influence of the heat accumulation of the wall and the like in the room is not considered in the conventional method of estimating the power consumption amount of the air conditioner. Therefore, an error of the estimation of the power consumption amount increases in the conventional method.

On the other hand, the embodiment proposes a power consumption amount estimation model in which the influence of the heat accumulation of the wall and the like in the room is considered using the room temperature at an initial stage (9:00) of the operation of the air conditioner. In the air conditioning information estimation device of the present embodiment, a room temperature x in the initial stage (13:00) of a prescribed period (for example, for one hour from 13:00 to 14:00), a temperature set-point xs of the air conditioner in the prescribed period, and a room temperature (initial temperature) xc at the beginning (9:00) of the air conditioning of the air conditioner are used to estimate a power consumption amount y of the air conditioner in the prescribed period.

a=x−xs

b=xc−xs

are obtained as two feature quantities in order to estimate the power consumption amount y. In the case of a large first feature quantity a, namely, in the case of a large difference between the room temperature x and the temperature set-point xs, it can be estimated that the power consumption amount y increases in the prescribed period. In the case of a large second feature quantity b, namely, in the case of a large difference between the room temperature xc and the temperature set-point xs at the beginning of the air conditioning, it is considered that a heat quantity accumulated around the room is large, and that the power consumption amount y also increases in the prescribed period. A model in which the influence of the heat accumulation of the wall and the like in the room is considered using the second feature quantity b is used in the present embodiment. The room temperature x changes in each period by the influences of the ambient temperature and air conditioning. Therefore, the first feature quantity a indicates the influences of time changes of the ambient temperature and room temperature with respect to the power consumption amount y.

In the present embodiment, the power consumption amount y of the air conditioner in the prescribed period is expressed by the following function with the first feature quantity a and the second feature quantity b as variables.

y=α×a+β×b+γ (1)

Where α, β, and γ are constants. The constants α, β, γ that express correlations of the first feature quantity a and second feature quantity b and the power consumption amount y can be determined based on actual measurement data. That is, the room temperature x in each period (for one hour), the temperature set-point xs in each period, the initial temperature xc at the beginning of the air conditioning prior to each period, and the power consumption amount y in each period are measured in the plural periods in which the air conditioner operates. The plural pieces of measurement data are substituted in the equation (1), and the optimum constants α, β, and γ can be obtained by a least square method or the like. In the case that the air conditioner operates in the daytime while stopping in nighttime as illustrated in FIG. 2, the initial temperature xc is common to the same day (the room temperature at the beginning of the running on that day). The cooling differs from the heating in the constants α, β, and γ of the function. The constant γ may be zero.

Any method, such as a multiple regression analysis and a genetic algorithm, in which the measurement data is fitted using a function may be adopted in addition to the least square method. The relationship between the first feature quantity a and second feature quantity b, which are of the variables, and the power consumption amount y is expressed by the simplest linear equation. Alternatively, another function, such as a quadratic equation, in which the first feature quantity a and the second feature quantity b are used as the variable may be used as follows.

Y=f(a)+g(b)+γ (2)

where f (a) and g (b) are arbitrary functions. In such cases, the pieces of measurement data can be approximated using the functions when the number of pieces of measurement data increases sufficiently. At this point, it is noted that the power consumption amount y is expressed with the first feature quantity a and the second feature quantity b as the variables. The constant γ may be zero.

In the case that the equation (1) is used, the power consumption amount y in the prescribed period (for one hour) can be estimated from the room temperature x, the temperature set-point xs, and the initial temperature xc using the function when the constants α, β, and γ of the function are determined based on the measurement data. The model of the embodiment is one in which the influences of the heat accumulation and the like are considered, and the power consumption amount can suitably be estimated in the case that the influence of the heat accumulation exists as illustrated in FIG. 2.

### Configuration of Air Conditioning Information Estimation Device

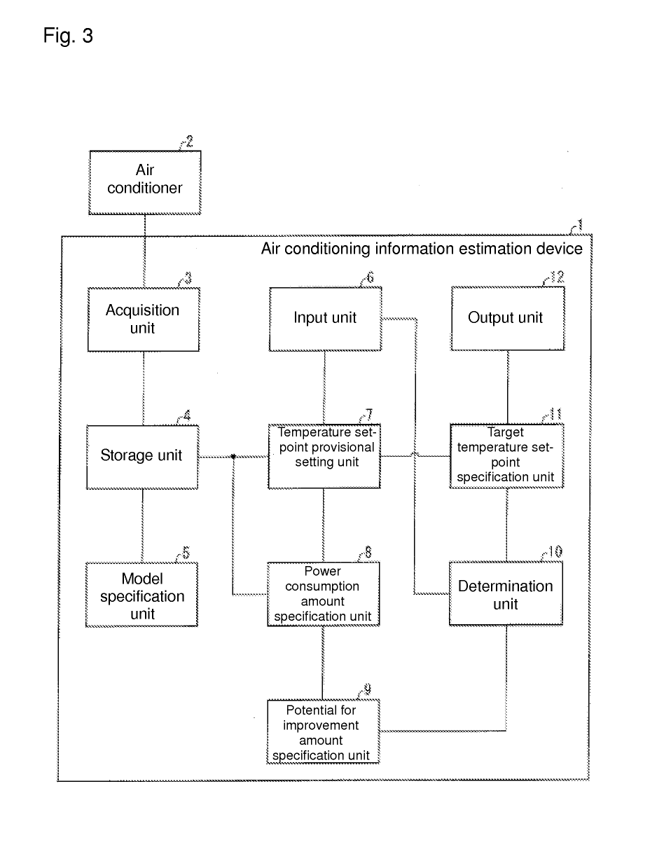

A configuration of the air conditioning information estimation device of the present embodiment will be described below. FIG. 3 is a block diagram illustrating a functional configuration of the air conditioning information estimation device 1.

The air conditioner 2 is one that performs the temperature control in a prescribed area (such as the room and the floor) of the building based on the temperature set-point. The air conditioner 2 consumes the power as energy of the air conditioning. Alternatively, the air conditioner 2 may operate by consuming the energy such as gas. The air conditioner 2 is a general one that measures the temperature of the circulating air and performs the air conditioning according to the difference with the temperature set-point. The air conditioner 2 measures the consumed power of itself to obtain the power consumption amount in each one hour.

The air conditioning information estimation device 1 includes an acquisition unit 3, a storage unit 4, a model specification unit (the function specification unit) 5, an input unit 6, a temperature set-point provisional setting unit 7, a power consumption amount specification unit (the consumption amount specification unit) 8, a potential for improvement amount specification unit (the difference specification unit) 9, a determination unit 10, a target temperature set-point specification unit 11, and an output unit 12.

The acquisition unit 3 acquires the running state (the power-on and -off of the air conditioner), the measured value of the room temperature in the initial stage of the prescribed period (for one hour), the temperature set-point in the prescribed period, and the measured value of the power consumption amount in the prescribed period from the air conditioner 2. The acquisition unit 3 stores the acquired measured value of the room temperature, temperature set-point, and measured value of the power consumption amount as the measurement data in the storage unit 4. The acquisition unit 3 stores the room temperature at the beginning of the operation of the air conditioner 2 as the initial temperature in the storage unit 4.

The acquisition unit 3 may acquire the data such as the measured value from another device that manages the air conditioner 2. For example, in the case that the air conditioners of the building are managed by a BEMS (Building and Energy Management System), the management device of the BEMS has pieces of information about the temperature set-points and power consumption amounts and the like of the air conditioners and controls the air conditioners. In this case, the acquisition unit 3 may acquire the temperature set-point and the power consumption amount from the management device of the BEMS through a network or a recording medium. The acquisition unit 3 may acquire the measured value of the room temperature from a temperature sensor disposed in the room, and acquire the information on the power from a power sensor provided corresponding to the air conditioner 2.

The model specification unit 5 specifies a power consumption amount estimation function that estimates the power consumption amount y using the pieces of measurement data in the plural periods. Specifically, the model specification unit 5 acquires the room temperatures x, temperature set-points xs, initial temperatures xc, and power consumption amounts y in the plural periods from the storage unit 4. In each period, the model specification unit 5 obtains the first feature quantity a (=x−xs) wherein the difference between the room temperature x and the temperature set-point xs, and obtains the second feature quantity b (=xc−xs) wherein the difference between the initial temperature xc and the temperature set-point xs. Using the first feature quantities a, second feature quantities b, and power consumption amounts y in the plural periods, the model specification unit 5 specifies the constants α, β, and γ of the power consumption amount estimation function expressed by the equation (1). As described above, the model specification unit 5 obtains the constants α, β, and γ that successfully approximate the plural pieces of measurement data by the least square method. The model specification unit 5 stores the specified power consumption amount estimation function (the constants α, β, and γ of the function) in the storage unit 4.

Based on the target reduction rate of the power consumption amount, the air conditioning information estimation device 1 obtains the target temperature set-point suitable to reduce the power consumption amount with respect to the room temperature x and the initial temperature xc. The air conditioning information estimation device 1 also obtains how much power consumption amount can be reduced (or was able to be reduced). However, in the case of the cooling, an upper limit of the temperature is set to a limit temperature such that the comfort is not lost. In the case of the heating, a lower limit of the temperature is set to the limit temperature. The case that the suitable temperature set-point at that time and the power consumption amount that was able to be reduced are estimated based on the past measurement data will be described below.

The input unit 6 receives an input from the outside with respect to designation of a target day (a target period) indicating what day the processing is performed, a target reduction rate zr of the power consumption amount on one day (the target period), a limit temperature xm indicating the upper limit of the temperature as a management index, a threshold zt indicating an allowable width for the target reduction rate zr, and designation of the cooling or heating. The input unit 6 outputs the received pieces of information to the temperature set-point provisional setting unit 7. The input unit 6 outputs the target reduction rate zr of the power consumption amount and the threshold zt to the determination unit 10. The input unit 6 may receive the pieces of information from the user through a key or the like, acquire the pieces of information from the storage unit 4, and acquire the pieces of information from another computer through the network. The input unit 6 may store the pieces of information in the storage unit 4.

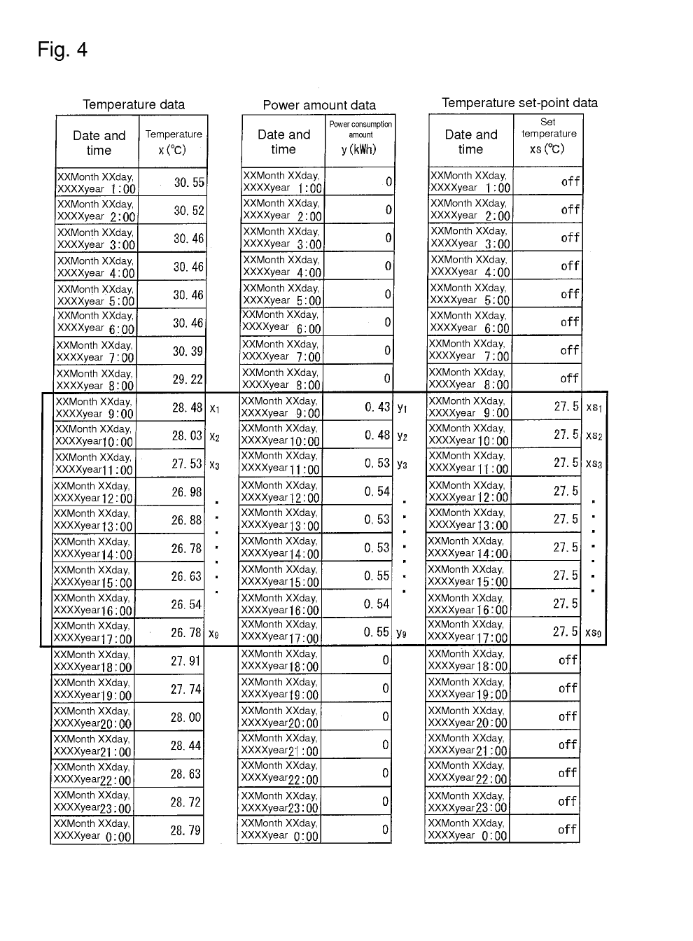

The temperature set-point provisional setting unit 7 acquires the pieces of measurement data (the room temperature x and the temperature set-point xs) in each period (every one hour) included in the target day from the storage unit 4 according to the designated target day. FIG. 4 is a view illustrating an example of the measurement data read in the temperature set-point provisional setting unit 7. FIG. 4 illustrates the room temperature data, the power amount data of the corresponding air conditioner, and the temperature set-point data. An operation time of the air conditioner ranges from 9:00 to 18:00. The temperature set-point provisional setting unit 7 acquires the measurement data only in the period in which the air conditioner 2 operates. For example, in the case that the air conditioner 2 operates from 9:00 to 18:00, the temperature set-point provisional setting unit 7 acquires nine sets of pieces of measurement data for each one hour. In the pieces of measurement data In FIG. 4, the temperature set-point provisional setting unit 7 reads the temperatures x (x₁, x₂, . . . , and x₉) and temperature set-points xs (xs₁, xs₂, . . . , and xs₉) for nine hours from 9:00 to 18:00, which are surrounded by a thick frame. The temperature x₁ in a field of “9:00” in FIG. 4 indicates the temperature at a clock time 9:00, and the temperature set-point xs₁ in the field of “9:00” indicates the (average) temperature set-point between clock times 9:00 and 10:00. The temperature x₁ at 9:00 at which the air conditioning is started corresponds to the initial temperature xc.

The temperature set-point provisional setting unit 7 obtains a maximum temperature max (x) of the room temperature x in the prescribed period while the air conditioner 2 operates on the target day. At this point, a period in which the room temperature should be adjusted to the limit temperature or less (during the cooling) (a comfort maintaining period) is set to the prescribed period. For example, a period from the clock time 10:00 at which the effect of the air conditioning is sufficiently exerted after the air conditioning is started to the clock time 18:00 at which the air conditioner 2 operates finally is set to the prescribed period. In this case, the maximum temperature max (x) of the room temperature x in the prescribed period indicates max (x₂, x₃, . . . , and x₉).

The temperature set-point provisional setting unit 7 obtains the difference between the limit temperature xm and the maximum temperature max (x) as Δxm.

Δxm=xm−max(x) (Cooling)

Δxm=min(x)−xm (Heating)

Because Δxm indicates the difference between the maximum temperature max (x) and the limit temperature xm while the air conditioning is performed on the target day, it is considered that at least the power consumption amount corresponding to Δxm was able to be reduced. The temperature set-point provisional setting unit 7 obtains a provisional temperature set-point xs′ in each period corresponding to the temperature set-point xs in the period on the target day according to Δxm and a correction value Δx′ of the temperature set-point. An initial value of Δx′ is zero.

xs′=xs+(Δxm−Δx′) (Cooling)

xs′=xs−(Δxm−Δx′) (Heating)

In the case of the cooling, the initial value of the provisional temperature set-point xs′ is set to a value such that the room temperature x is maintained at the limit temperature xm or less in the prescribed period (between the clock times 10:00 and 18:00).

The temperature set-point provisional setting unit 7 outputs the obtained provisional temperature set-point xs′ in each period to the power consumption amount specification unit 8. The temperature set-point provisional setting unit 7 outputs the obtained provisional temperature set-point xs′, correction value Δx′, and Δxm to the target temperature set-point specification unit 11.

The power consumption amount specification unit 8 acquires the power consumption amount estimation function (the constants α, β, and γ of the function) and the pieces of measurement data (the room temperature x and the initial temperature xc) in each period on the target day from the storage unit 4. The temperature x₁ at 9:00 at which the air conditioning is started corresponds to the initial temperature xc. In each period in which the air conditioner 2 operates on the target day, the power consumption amount specification unit 8 specifies a power consumption amount y′, to which the provisional temperature set-point xs′ is applied, using the power consumption amount estimation function. That is, in each period, a provisional first feature quantity a′ is obtained from the room temperature x and the provisional temperature set-point xs′, and a provisional second feature quantity b′ is obtained from the initial temperature xc and the provisional temperature set-point xs′.

a′=x−xs′

b′=xc−xs′

In each period, the power consumption amount y′ corresponding to the provisional first feature quantity a′ and provisional second feature quantity b′ is specified using the power consumption amount estimation function.

y′=α×a′+β×b′+γ

The power consumption amount specification unit 8 outputs the specified power consumption amount y′ in each period to the potential for improvement amount specification unit 9.

The potential for improvement amount specification unit 9 acquires the measurement data (power consumption amount y) in each period on the target day from the storage unit 4. In the pieces of measurement data in FIG. 4, the potential for improvement amount specification unit 9 reads the power consumption amount y (y₁, y₂, . . . , and y₉) for nine hours from 9:00 to 18:00, which are surrounded by the thick frame. The power consumption amount y₁ in the field of “9:00” in FIG. 4 indicates the power consumption amount between the clock times 9:00 and 10:00. In each period, the potential for improvement amount specification unit 9 obtains the difference (the energy consumption amount difference) between the actual power consumption amount y at the temperature set-point xs and the estimated power consumption amount y′ at the temperature set-point xs′ as a potential for improvement amount Δy of the power consumption amount.

Δy=y−y′

The potential for improvement amount Δy in each period is the power consumption amount that is estimated to be able to be reduced by changing the temperature set-point from xs to xs′ in the period. The potential for improvement amount specification unit 9 outputs the potential for improvement amount Δy in each period to the determination unit 10.

The determination unit 10 obtains the total of potential for improvement amounts Δy in the periods on the target day, and specifies the total of potential for improvement amounts Δy as an accumulative potential for improvement amount Δz on the target day.

Δz=ΣΔy

The determination unit 10 obtains an accumulative power consumption amount z, in which the power consumption amounts y in the periods on the target day are added, from the pieces of measurement data.

Z=Σy

A ratio Δz/z of the accumulative potential for improvement amount Δz and the accumulative power consumption amount z is the reduction rate of the power consumption amount on the target day in the case that the temperature set-point is changed from xs to xs′. The determination unit 10 determines whether the reduction rate Δz/z falls within a prescribed range defined by the target reduction rate zr and the threshold zt indicating the allowable width based on whether the obtained reduction rate Δz/z satisfies the following equation.

|(Δz/z)−zr|≦zt

That is, the determination unit 10 determines whether the difference between the reduction rate Δz/z and target reduction rate zr of the power consumption amount is less than or equal to the threshold zt. The determination unit 10 outputs a determination result to the target temperature set-point specification unit 11.

The target temperature set-point specification unit 11 specifies the target temperature set-point in each period and the corresponding potential for improvement amount Δy (and the accumulative potential for improvement amount Δz) in the period according to the determination result of the determination unit 10, and outputs the target temperature set-point and the potential for improvement amount Δy (and the accumulative potential for improvement amount Δz) to the output unit 12.

In the case that the reduction rate Δz/z falls within the prescribed range in the determination result, the target temperature set-point specification unit 11 sets the provisional temperature set-point xs′ to the target temperature set-point, and outputs the target temperature set-point and the corresponding potential for improvement amount Δy in each period to the output unit 12.

In the case that the reduction rate Δz/z does not exist in the prescribed range in the determination result, the target temperature set-point specification unit 11 changes the correction value Δx′ in order to correct (change) the provisional temperature set-point xs′. The target temperature set-point specification unit 11 changes the correction value Δx′ within a range (0≦Δx′≦Δxm), and outputs the changed correction value Δx′ to the temperature set-point provisional setting unit 7. The provisional temperature set-point xs′ changes when the correction value Δx′ changes. Therefore, the reduction rate Δz/z at the post-change provisional temperature set-point xs′ is obtained, and the change of the correction value Δx′ is repeated until the reduction rate Δz/z falls within the prescribed range.

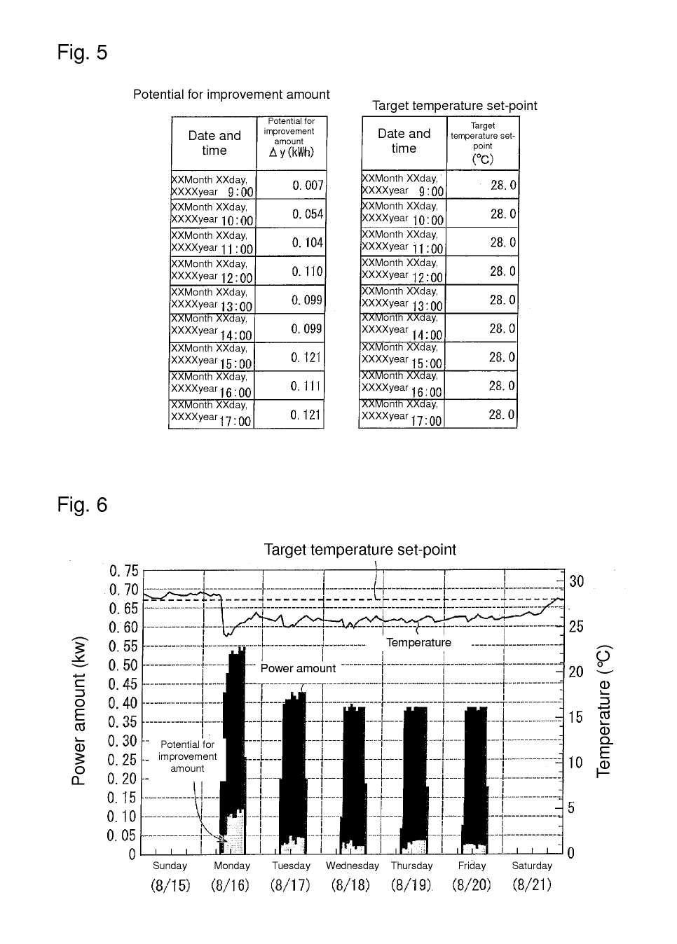

The output unit 12 displays the received target temperature set-point and corresponding potential for improvement amount Δy in each period on a display device, and present the target temperature set-point and the potential for improvement amount Δy to the user. The output unit 12 may transmit the target temperature set-point and the corresponding potential for improvement amount Δy in each period to an external database, or output and store the target temperature set-point and the potential for improvement amount Δy to and in the storage unit 4. FIG. 5 is a view illustrating the potential for improvement amount Δy and the target temperature set-point, which are displayed or output. Additionally the output unit 12 may display or output specified other pieces of information such as the accumulative potential for improvement amount Δz.

FIG. 6 is a view, that corresponds to FIG. 2 and illustrates display examples of the potential for improvement amount Δy and target temperature set-point. FIG. 6 illustrates the power consumption amount in each time and the potential for improvement amount Δy of the power consumption amount. FIG. 6 also illustrates the target temperature set-point. The display in FIG. 6 allows the user to easily understand the potential for improvement amount in the time (period) on the day.

### Processing of Air Conditioning Information Estimation Device

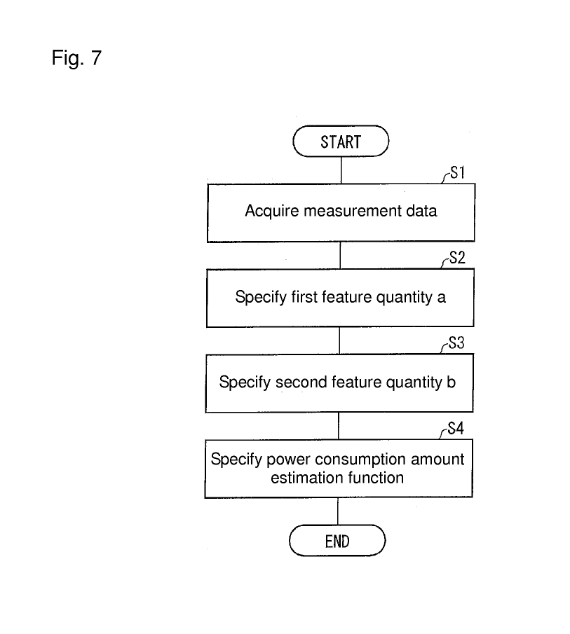

A processing flow of the air conditioning information estimation device 1 will be described below. FIG. 7 is a view illustrating the processing flow in which the air conditioning information estimation device 1 specifies the power consumption amount estimation function.

The model specification unit 5 acquires the room temperatures x, temperature set-points xs, initial temperatures xc, and power consumption amounts y in the plural periods from the storage unit 4 (S1).

The model specification unit 5 obtains the first feature quantity a (=x−xs) which is the difference between the room temperature x and the temperature set-point xs (S2) for each period.

The model specification unit 5 obtains the second feature quantity b (=xc−xs) which is the difference between the initial temperature xc and the temperature set-point xs (S3).

Using the first feature quantities a, second feature quantities b, and power consumption amounts y in the plural periods, the model specification unit 5 specifies the constants α, β, and γ of the power consumption amount estimation function by the least square method. The power consumption amount estimation function approximates the pieces of measurement data, and is expressed by

y=α×a+β×b+γ (1)

(S4). Therefore, the processing of specifying the power consumption amount estimation function is ended.

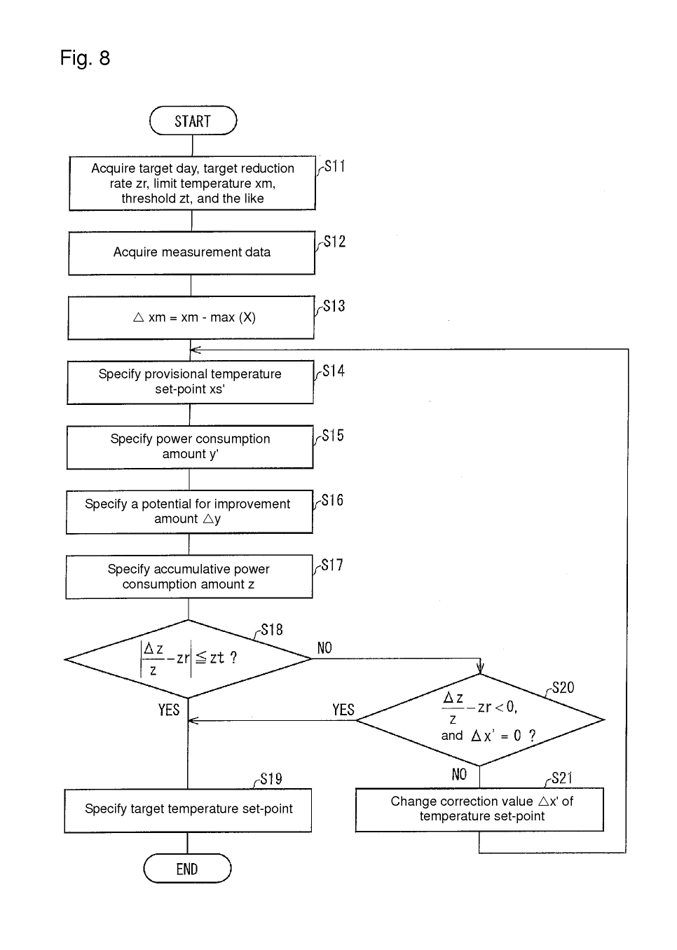

FIG. 8 is a view illustrating a processing flow in which the air conditioning information estimation device 1 estimates the power consumption amount to specify the target temperature set-point and the potential for improvement amount.

The input unit 6 acquires the designation of the target day, the target reduction rate zr of the power consumption amount on the target day, the limit temperature xm indicating the upper limit of the temperature as the management index, the threshold zt indicating the allowable width for the target reduction rate zr, and the designation of the cooling or heating from the outside (S11). At this point, the case that the cooling is designated will be described.

The temperature set-point provisional setting unit 7 acquires the pieces of measurement data (the room temperature x and the temperature set-point xs) in each period (every one hour) included in the target day from the storage unit 4 (S12).

The temperature set-point provisional setting unit 7 specifies the difference Δxm between the limit temperature xm and the maximum temperature max (x) of the room temperature x on the target day (S13).

Δxm=xm−max(x) (Cooling)

The temperature set-point provisional setting unit 7 sets the initial value of Δx′ to zero. The temperature set-point provisional setting unit 7 also sets an initial value of a parameter t1 of a bisection method to zero, and sets an initial value of a parameter t2 to Δxm.

The temperature set-point provisional setting unit 7 specifies the provisional temperature set-point xs′ in each period (S14).

xs′=xs+(Δxm−Δx′) (Cooling)

At this first stage, in consideration of the limit temperature xm and the maximum temperature max (x), the provisional temperature set-point xs′ is set to the (highest) temperature set-point of the allowable limit of the comfort such that the air conditioning is weakened.

The power consumption amount specification unit 8 obtains the provisional first feature quantity a′ and the provisional second feature quantity b′.

a′=x−xs′

b′=xc−xs′

The power consumption amount specification unit 8 specifies (estimates) the power consumption amount y′, to which the provisional set temperature xs′ is applied, in each period on the target day based on the power consumption amount estimation function stored in the storage unit 4 (S15).

y′=α×a′+β×b′+γ

The potential for improvement amount specification unit 9 obtains the difference between the actual power consumption amount y at the temperature set-point xs and the estimated power consumption amount y′ at the temperature set-point xs′ as the potential for improvement amount Δy of the power consumption amount in each period (S16).

Δy=y−y′

The determination unit 10 specifies the accumulative potential for improvement amount Δz on the target day and the accumulative power consumption amount z on the target day (S17).

Δz=ΣΔy

Z=Σy

The determination unit 10 determines whether the difference between the reduction rate Δz/z and target reduction rate zr of the power consumption amount is less than or equal to the threshold zt (S18).

|(Δz/z)−zr|≦zt

When the difference between the reduction rate Δz/z and target reduction rate zr of the power consumption amount is less than or equal to the threshold zt (Yes in S18), the target temperature set-point specification unit 11 specifies the provisional temperature set-point xs′ as the target temperature set-point (S19). Then, the output unit 12 displays the target temperature set-point and the corresponding potential for improvement amount Δy in each period on the display device, and the processing is ended.

When the difference between the reduction rate Δz/z and target reduction rate zr of the power consumption amount is greater than the threshold zt (No in S18), the target temperature set-point specification unit 11 determines whether a condition of exception processing is satisfied (S20).

In the case of (Δz/z)−zr<0 and Δx′=0 (Yes in S20), the target temperature set-point specification unit 11 sets the current provisional temperature set-point xs′ to the target temperature set-point as the exception processing (S19). In the case that the condition of the exception processing is satisfied, it is considered that the provisional temperature set-point xs′ in each period is the limit value, and possibly the temperature in one of the periods exceeds the limit temperature xm to lose the comfort when the provisional temperature set-point xs′ is further raised in order to increase the reduction rate of the power consumption amount.

In the case of (Δz/z)−zr>0 or Δx′≠0 (No in S20), the target temperature set-point specification unit 11 changes the correction value Δx′ of the temperature set-point within the range (0≦Δx′≦Δxm) (S21). At this point, the bisection method is adopted in order to search the suitable correction value Δx′. Specifically, the value of the parameter t1 is set to Δx′ in the case of (Δz/z)−zr>0, and the value of the parameter t2 is set to Δx′ in the case of (Δz/z)−zr<0. An average value of the parameter t1 and the parameter t2 is set to a new correction value Δx′.

Δx′=(t1+t2)/2

The correction value Δx′ is not limited to the bisection method. Alternatively, the correction value Δx′ may gradually be stepped up and decided, or the correction value Δx′ may be decided using other methods such as a Newton method and the genetic algorithm.

After the correction value Δx′ of the temperature set-point is changed in S21, the flow returns to S14 to repeat the processing. Therefore, the more suitable temperature set-point can be specified by changing the provisional temperature set-point xs′.

In the present embodiment, the provisional temperature set-point xs′ is initially set to the limit value to obtain the reduction rate Δz/z of the power consumption amount. It is considered that the case that the reduction rate Δz/z of the power consumption amount excessively exceeds the target reduction rate zr ((Δz/z)−zr>zt) is the case that, in order to excessively reduce the power consumption amount, the cooling is weakened to sacrifice the comfort. In such cases, the correction value Δx′ is changed to change the temperature set-point xs′. Therefore, the target temperature set-point is specified such that a reduction standard that is of the target reduction rate zr is achieved and such that the temperature environment is comfortable to a person who uses the room.

How much power consumption amount can be reduced using the past measurement data while the comfort is maintained and the specification of the temperature set-point (the target temperature set-point) at that time are described above. In the air conditioning information estimation device 1 of the present embodiment, using the power consumption amount estimation function, the power consumption amount can be estimated in consideration of the influence of the heat accumulation in the case that the temperature set-point is assumed. Nowadays, frequently the target reduction rate is set to the reduction target of the amount of carbon dioxide emission or energy compared with the same month in the previous year. In the air conditioning information estimation device 1, the optimum temperature set-point and the a reduction potential (the reduction rate) of the power consumption amount can be specified based on the reduction target of the power consumption amount in a future period (for example, next month) with the measurement data (for example, average data) of the same month in the previous year as the past measurement data. Therefore, the optimum temperature set-point in the future period can be decided and used in the energy saving.

In the present embodiment, the power consumption amount estimation function is specified only according to the measurement data (the measured value of the room temperature, the initial temperature in the room, the temperature set-point, and the measured value of the power consumption amount), so that the power consumption amount estimation function suitable for various types of air conditioners and rooms (areas) of buildings in various environments can be specified. Because the measurement data of the ambient temperature is not used in the present embodiment, it is not necessary to measure the ambient temperature, and it is not necessary to spend the work such that the sensor is disposed outside the building. The measurement data necessary for the air conditioning information estimation device 1 is the information possessed by a general air conditioner, and the measurement data can be acquired only from the air conditioner. The air conditioning information estimation device can be introduced by installing a program, which implements the function of the air conditioning information estimation device of the present embodiment, on the computer or the like. Therefore, the air conditioning information estimation device 1 has advantages of the low introduction cost and the easy introduction.

In the present embodiment, the target temperature set-point is specified based on the target reduction rate. Alternatively, the suitable target temperature set-point may be specified according to the (accumulative) potential for improvement amount, the estimated value y′ of the power consumption amount, or the value (target value) of the estimated value Σy′ of the accumulative power consumption amount.

The air conditioner that operates by consuming the power as the energy is described in the present embodiment. Alternatively, at least an embodiment is applied to the air conditioner that operates by consuming the gas as the energy, and the reduction potential of the gas consumption amount can be estimated.

The air conditioning information estimation device of the present embodiment may be incorporated in the air conditioner, and display the power reduction amount (the potential for improvement amount) or the target temperature set-point on a display equipped in the air conditioner or a display of a remote controller (a control instruction device).

The estimations of the target temperature set-point and potential for improvement amount are not limited to the unit of one day, but the estimations may be performed in one period (for example, one hour).

The period in which the room temperature should be maintained at the limit temperature xm or less (the period in which the comfort is maintained) may arbitrarily be decided. For example, typical part of the period in which the air conditioner 2 operates may be used as the period in which the comfort is maintained. That is, Δxm may be decided using an average value or an intermediate value of x (x₁, x₂, . . . , and x₉) instead of max (x). For example, assuming that Δxm is the value in which the intermediate value of x on the target day is subtracted from xm, the provisional temperature set-point xs′ is set to the value in which the temperature in at least about a half of the period of the target day is maintained at the limit temperature xm or less. The period in which the comfort is maintained may be set to a certain period (one hour) in which the air conditioner 2 operates. That is, Δxm=xm−min (x) may be obtained.

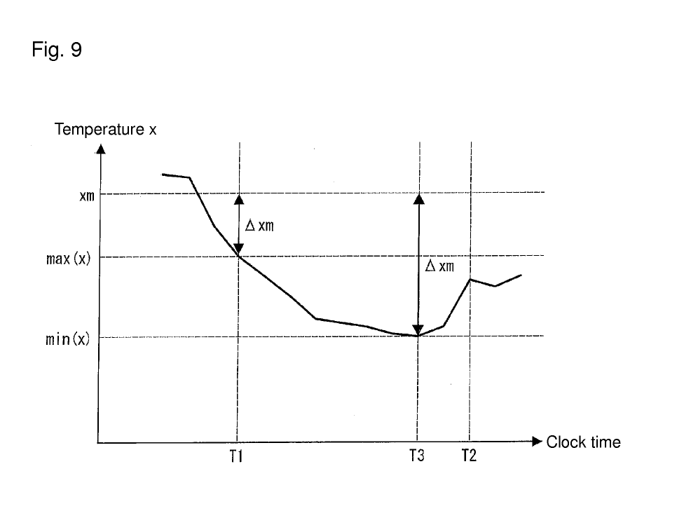

FIG. 9 is a graph illustrating the room temperature x and Δxm when the air conditioning is performed at a certain temperature set-point. In the case that the temperature in a prescribed period (clock times T1 to T2) is maintained at the limit temperature xm or less while the air conditioner 2 operates (performs the cooling), the provisional temperature set-point xs′ may be decided using Δxm=xm−max (x). In the case that the temperature in at least one period is maintained at the limit temperature xm or less, the provisional set temperature xs′ may be decided using Δxm=xm−min (x).

Each block of the air conditioning information estimation device 1, particularly the acquisition unit 3, the model specification unit 5, the input unit 6, the temperature set-point provisional setting unit 7, the power consumption amount specification unit 8, the potential for improvement amount specification unit 9, the determination unit 10, the target temperature set-point specification unit 11, and the output unit 12 may be constructed by a hardware logic, or by software using a CPU (Central Processing Unit).

That is, the air conditioning information estimation device 1 includes the CPU that executes a command of a control program implementing each function, a ROM (Read Only Memory) in which the control program is stored, a RAM (Random Access Memory) in which the control program is expanded, and storage devices (recording medium), such as a memory, in which the control program and various pieces of data are stored. The object of at least an embodiment can also be achieved such that the recording medium in which a program code (an executable format program, an intermediate code program, and a source program) of the control program for the air conditioning information estimation device 1, which is of the software implementing the above functions, is stored while being readable by a computer is supplied to the air conditioning information estimation device 1, and such that the computer (or the CPU or an MPU (Micro Processor Unit)) reads and executes the program code recorded in the recording medium.

Examples of the recording medium include tape systems, such as a magnetic tape and a cassette tape, disk systems including such magnetic disks as a floppy disk (registered trademark) and a hard disk, and such optical disks as a CD-ROM (Compact Disc Read-Only Memory), an MO (Magneto-Optical), an MD (Mini Disc), a DVD (Digital Versatile Disk), and a CD-R (CD Recordable), card systems, such as an IC card (including a memory card) and an optical card, and semiconductor memory systems, such as a mask ROM, an EPROM (Erasable Programmable Read-Only Memory), an EEPROM (Electrically Erasable and Programmable Read-Only Memory), and a flash ROM.

The air conditioning information estimation device 1 may be configured to be able to be connected to a communication network, and the program code may be supplied through the communication network. There is no particular limitation to the communication network. Examples of the communication network include the Internet, an intranet, an extranet, a LAN (Local Area Network), an ISDN (Integrated Services Digital Network), a VAN (Value-Added Network), a CATV CATV (Community Antenna TeleVision) communication network, a virtual private network, a telephone line network, a mobile communication network, and a satellite communication network. There is no particular limitation to a transmission medium constituting the communication network. Examples of the transmission medium include wired lines, such as IEEE (Institute of Electrical and Electronic Engineers) 1394, a USB, a power-line carrier, a cable TV line, a telephone line, and an ADSL (Asynchronous Digital Subscriber Loop) line, and wireless lines, such as infrared rays, such as IrDA (Infrared Data Association) and a remote controller, Bluetooth (registered trademark), 802.11 wireless, HDR (High Data Rate), a mobile phone network, a satellite line, and a terrestrial digital network.

At least an embodiment can also be expressed as follows.

The air conditioning information estimation device may further include a function specification unit that specifies the functions f (a) and g (b), which approximate plural pieces of measurement data, by acquiring the plural pieces of measurement data in plural periods, each of the plural pieces of measurement data including a measured value of the atmospheric temperature in the prescribed area in a certain period of the plural periods, the temperature set-point set in the certain period, a measured value of the initial temperature corresponding to the certain period, and a measured value of the energy consumption amount of the air conditioner in the certain period, wherein the consumption amount specification unit specifies the value y, which is obtained using the function specified by the function specification unit, as the energy consumption amount.

According to the configuration, the function f (a), the function g (b), and the constant γ, which approximate the past measurement data, can be specified using the past measurement data. Therefore, the function suitable for the area and the air conditioner can be obtained based on the past measurement data. Therefore, the energy consumption amount can suitably be estimated.

The functions f (a) and g (b) may be linear functions, and the consumption amount specification unit may specify a value y of a function as the energy consumption amount, expressed by

y=α×a+β×b+γ

using a constant α, a constant β, and a constant γ.

According to the configuration, the function indicating the energy consumption amount can be expressed by the simplest linear equation using the first feature quantity a and the second feature quantity b as the variables.

The air conditioning information estimation device may further include a function specification unit that acquires measurement data in plural periods, the measurement data including a measured value of the atmospheric temperature in the prescribed area in a certain period of the plural periods, the temperature set-point set in the certain period, a measured value of the initial temperature corresponding to the certain period, and a measured value of the energy consumption amount of the air conditioner in the certain period, and specifies the constant α, constant β, and constant γ of the function such that the plural pieces of measurement data are approximated, wherein the consumption amount specification unit specifies the value y, which is obtained from the function using the constant α, the constant β, and the constant γ that are specified by the function specification unit, as the energy consumption amount.

According to the configuration, the constants α, β, and γ of the function that approximate the past measurement data can be specified using the past measurement data. Therefore, the function suitable for the area and the air conditioner can be obtained based on the past measurement data. Therefore, the energy consumption amount can suitably be estimated.

The air conditioning information estimation device may further include a difference specification unit that obtains a difference between the value y obtained from the function with a provisional temperature set-point as the temperature set-point in the prescribed period and the measured value of the energy consumption amount of the air conditioner in the certain period as an energy consumption amount difference.

According to the configuration, the difference (the energy consumption amount difference) between the energy consumption amount at the provisional temperature set-point and the measured value of the actual energy consumption amount can be obtained. The energy consumption amount difference indicates how much energy can be reduced when the air conditioner is set to provisional temperature set-point. Therefore, the user can estimate the suitable temperature set-point according to the energy reduction target and the energy reduction amount at that time.

The air conditioning information estimation device may further include: a determination unit that obtains the energy consumption amount difference in plural periods to determine whether an accumulated value of the energy consumption amount differences in the plural periods falls within a prescribed range; and a target temperature set-point specification unit that specifies the provisional temperature set-point in each period as the target temperature set-point in each period when the accumulated value of the energy consumption amount differences falls within the prescribed range, the target temperature set-point specification unit changing the provisional temperature set-point in each period to specify the target temperature set-point in each period until the accumulated value of the energy consumption amount differences falls within the prescribed range when the accumulated value of the energy consumption amount differences does not exist in the prescribed range.

According to the configuration, the target temperature set-point can be specified such that the accumulated value of the energy consumption amount differences in the plural periods falls within the prescribed range. Therefore, the target temperature set-point at which the reduction target is achieved can be obtained by setting the prescribed range according to the reduction target of the energy consumption amount.

The air conditioning information estimation device may further include a temperature set-point provisional setting unit that assumes the provisional temperature set-point such that the air conditioning is weakened according to a difference between a prescribed limit value of the temperature set-point and a measured value of the atmospheric temperature in the prescribed period and the temperature set-point in the certain period, wherein the difference specification unit obtains the value y from the function using the provisional temperature set-point assumed by the temperature set-point provisional setting unit.

According to the configuration, the provisional temperature set-point can be obtained when the atmospheric temperature in the prescribed area does not exceed the limit value (when the atmospheric temperature does not exceed the limit value in the case of the cooling, and when the atmospheric temperature does not fall below the limit value in the case of the heating) even if the provisional temperature set-point is applied. The limit value is set in consideration of the comfort, whereby the provisional set temperature is assumed in consideration of the comfort and the energy saving. Therefore, the energy consumption amount can be estimated in that case.

The consumption amount specification unit may specify the energy consumption amount, assuming that x is the atmospheric temperature in the prescribed area at an initial stage in the prescribed period while the air conditioner performs the air conditioning.

In the prescribed period, because the atmospheric temperature in the prescribed area is affected by set temperature in the certain period and changes, preferably the temperature at the initial stage in the certain period is used as the atmospheric temperature x that is used to obtain the value y of the function.

The air conditioner according to an embodiment includes the air conditioning information estimation device.

The air conditioning information estimation device may partially be constructed by a computer. In this case, the embodiment also includes a control program that causes a computer to operate as each unit of the air conditioning information estimation device and a computer-readable recording medium in which the control program is recorded.

The present invention is not limited to the embodiment, but various changes can be made without departing from the scope of the present invention. That is, an embodiment obtained by a combination of technical means, which are properly changed without departing from the scope of the present invention, is also included in the technical scope of the present invention.

### INDUSTRIAL APPLICABILITY

The present invention can be applied to the air conditioning information estimation device that estimates the power consumption amount in changing the temperature set-point.

### DESCRIPTION OF SYMBOLS

1 Air conditioning information estimation device
2 Air conditioner
3 Acquisition unit
4 Storage unit
5 Model specification unit (function specification unit)
6 Input unit
7 Temperature set-point provisional setting unit
8 Power consumption amount specification unit (consumption amount specification unit)
9 Potential for improvement amount specification unit (difference specification unit)
10 Determination unit
11 Target temperature set-point specification unit
12 Output unit

1. An air conditioning information estimation device for estimating an energy consumption amount of an air conditioner, the air conditioner being for adjusting an atmospheric temperature in a prescribed area based on a temperature set-point,
the air conditioning information estimation device comprising:
a storage unit configured to store a temperature set-point;
a consumption amount specification unit configured to specify the energy consumption amount of the air conditioner in a prescribed period in which the air conditioner is configured to perform air conditioning as a value y of a function, the function being expressed by
y=f(a)+g(b)+γ
using a function f (a) in which a first feature quantity a wherein a=x−xs is used as a variable, a function g (b) in which a second feature quantity b wherein b=xc−xs is used as a variable, and a constant γ,
where x is the atmospheric temperature in the prescribed area in the prescribed period, xs is the temperature set-point in the prescribed period, and xc is the initial atmospheric temperature in the prescribed area when the air conditioner starts the air conditioning before the prescribed period.

2. The air conditioning information estimation device according to claim 1, further comprising a function specification unit configured to specify the functions f(a) and g(b) and the constant γ, which approximate a plurality of pieces of measurement data, by acquiring the plurality of pieces of measurement data in a plurality of periods, each of the plurality of pieces of measurement data including a measured value of the atmospheric temperature in the prescribed area in a certain period of the plurality of periods, the temperature set point set in the certain period, a measured value of the initial temperature corresponding to the certain period, and a measured value of the energy consumption amount of the air conditioner in the certain period,
wherein the consumption amount specification unit is configured to specify the value y, which is obtained using the function specified by the function specification unit, as the energy consumption amount.

3. The air conditioning information estimation device according to claim 1, wherein the functions f (a) and g (b) are linear functions, and the consumption amount specification unit is configured to specify a value y of a function as the energy consumption amount, expressed by
y=α×a+β×b+γ
using a constant α, a constant β, and a constant γ.

4. The air conditioning information estimation device according to claim 3, further comprising a function specification unit configured to acquire a plurality of pieces of measurement data in a plurality of periods, the measurement data including a measured value of the atmospheric temperature in the prescribed area in a certain period of the plurality of periods, the temperature set-point set in the certain period, a measured value of the initial temperature corresponding to the certain period, and a measured value of the energy consumption amount of the air conditioner in the certain period, and specifies the constant α, constant β, and constant γ of the function which approximate the plurality of pieces of measurement data,
wherein the consumption amount specification unit is configured to specify the value y, which is obtained from the function using the constant α, the constant β, and the constant γ that are specified by the function specification unit, as the energy consumption amount.

5. The air conditioning information estimation device according to claim 1, further comprising a difference specification unit configured to obtain a difference between the value y obtained from the function with a provisional temperature set-point as the temperature set-point in the prescribed period and the measured value of the energy consumption amount of the air conditioner in the prescribed period as an energy consumption amount difference.

6. The air conditioning information estimation device according to claim 5, further comprising: a determination unit configured to to determine whether an accumulated value of the energy consumption amount differences in the plurality of periods falls within a prescribed range based on the energy consumption amount difference obtained from the difference specification unit; and
a target temperature set-point specification unit configured to specify the provisional temperature set-point in each period as the target temperature set-point in each period when the accumulated value of the energy consumption amount differences falls within the prescribed range, the target temperature set-point specification unit changing the provisional temperature set-point in each period to specify the target temperature set-point in each period until the accumulated value of the energy consumption amount differences falls within the prescribed range when the accumulated value of the energy consumption amount differences does not exist in the prescribed range.

7. The air conditioning information estimation device according to claim 5, further comprising a temperature set-point provisional setting unit configured to assume the provisional temperature set-point such that the air conditioning is weakened according to a difference between a prescribed limit value of the temperature set-point and a measured value of the atmospheric temperature in the prescribed period and the temperature set-point in the certain period,
wherein the difference specification unit is configured to obtain the value y from the function using the provisional temperature set-point assumed by the temperature set-point provisional setting unit.

8. The air conditioning information estimation device according to claim 1, wherein the consumption amount specification unit is configured to specify the energy consumption amount, assuming that x is the atmospheric temperature in the prescribed area at an initial stage in the prescribed period while the air conditioner performs the air conditioning.

9. An air conditioner comprising the air conditioning information estimation device according to claim 1.

10. A method of controlling an air conditioning information estimation device configured to estimate an energy consumption amount of an air conditioner, the air conditioner adjusting an atmospheric temperature in a prescribed area based on a temperature set-point,
the method of controlling the air conditioning information estimation device comprising a consumption amount specification step of specifying the energy consumption amount of the air conditioner in a prescribed period in which the air conditioner performs air conditioning as a value y of a function, the function being expressed by
y=f(a)+g(b)+γ
using a function f (a) in which a first feature quantity a wherein a=x−xs is used as a variable, a function g (b) in which a second feature quantity b wherein b=xc−xs is used as a variable, and a constant γ,
where x is the atmospheric temperature in the prescribed area in the prescribed period, xs is the temperature set-point in the prescribed period, and xc is the initial atmospheric temperature in the prescribed area when the air conditioner starts the air conditioning before the prescribed period.

11. A computer-readable medium, having stored thereon a control program including instructions which when executed on a computer, causes the computer to execute a consumption amount specification step of specifying the energy consumption amount of an air conditioner in a prescribed period in which the air conditioner is configured to perform air conditioning as a value y of a function, the function being expressed by
y=f(a)+g(b)+γ
using a function f (a) in which a first feature quantity a wherein a=x−xs is used as a variable, a function g (b) in which a second feature quantity b wherein b=xc−xs is used as a variable, and a constant γ,
where x is the atmospheric temperature in the prescribed area in the prescribed period, xs is the temperature set-point in the prescribed period, and xc is the initial atmospheric temperature in the prescribed area when the air conditioner starts the air conditioning before the prescribed period.

12. The air conditioning information estimation device according to claim 2, further comprising a difference specification unit configured to obtain a difference between the value y obtained from the function with a provisional temperature set-point as the temperature set-point in the prescribed period and the measured value of the energy consumption amount of the air conditioner in the prescribed period as an energy consumption amount difference.

13. The air conditioning information estimation device according to claim 3, further comprising a difference specification unit configured to obtain a difference between the value y obtained from the function with a provisional temperature set-point as the temperature set-point in the prescribed period and the measured value of the energy consumption amount of the air conditioner in the prescribed period as an energy consumption amount difference.

14. The air conditioning information estimation device according to claim 4, further comprising a difference specification unit configured to obtain a difference between the value y obtained from the function with a provisional temperature set-point as the temperature set-point in the prescribed period and the measured value of the energy consumption amount of the air conditioner in the prescribed period as an energy consumption amount difference.

15. The air conditioning information estimation device according to claim 2, wherein the consumption amount specification unit is configured to specify the energy consumption amount, assuming that x is the atmospheric temperature in the prescribed area at an initial stage in the prescribed period while the air conditioner performs the air conditioning.

16. The air conditioning information estimation device according to claim 3, wherein the consumption amount specification unit is configured to specify the energy consumption amount, assuming that x is the atmospheric temperature in the prescribed area at an initial stage in the prescribed period while the air conditioner performs the air conditioning.

17. The air conditioning information estimation device according to claim 4, wherein the consumption amount specification unit is configured to specify the energy consumption amount, assuming that x is the atmospheric temperature in the prescribed area at an initial stage in the prescribed period while the air conditioner performs the air conditioning.

18. The air conditioning information estimation device according to claim 5, wherein the consumption amount specification unit is configured to specify the energy consumption amount, assuming that x is the atmospheric temperature in the prescribed area at an initial stage in the prescribed period while the air conditioner performs the air conditioning.

19. The air conditioning information estimation device according to claim 6, wherein the consumption amount specification unit is configured to specify the energy consumption amount, assuming that x is the atmospheric temperature in the prescribed area at an initial stage in the prescribed period while the air conditioner performs the air conditioning.

20. The air conditioning information estimation device according to claim 7, wherein the consumption amount specification unit is configured to specify the energy consumption amount, assuming that x is the atmospheric temperature in the prescribed area at an initial stage in the prescribed period while the air conditioner performs the air conditioning.
